(19) United States
(12) Patent Application Publication
(10) Pub. No.: US 2025/0119528 A1
(43) Pub. Date: Apr. 10, 2025

(54) CROSS COMPONENT PREDICTION MERGE CANDIDATE DERIVATION AND FUSION IN CHROMA CODING

(71) Applicant: QUALCOMM Incorporated, San Diego, CA (US)

(72) Inventors: Po-Han Lin, Taipei (TW); Jian-Liang Lin, Su'ao Township (TW); Yao-Jen Chang, San Diego, CA (US); Vadim Seregin, San Diego, CA (US); Marta Karczewicz, San Diego, CA (US)

(21) Appl. No.: 18/904,743

(22) Filed: Oct. 2, 2024

Related U.S. Application Data
(60) Provisional application No. 63/587,969, filed on Oct. 4, 2023.

(51) Int. Cl. H04N 19/105; H04N 19/11; H04N 19/159; H04N 19/176; H04N 19/186; H04N 19/593; H04N 19/70

(52) U.S. Cl. CPC H04N 19/105; H04N 19/11; H04N 19/159; H04N 19/176; H04N 19/186; H04N 19/593; H04N 19/70

(57) ABSTRACT

A device for decoding encoded video data is configured to determine that a chroma block of the encoded video data is coded in a cross-component prediction (CCP) mode; generate a merge candidate list for the chroma block, wherein the merge candidate list includes at least two prediction candidates generated by different CCP modes and a third prediction candidate, wherein the third prediction candidate comprises a fusion prediction candidate; receive, in the encoded video data, a syntax element set to a value; select a prediction candidate from the merge candidate list based on the value of the syntax element; determine a prediction block for the chroma block based on the selected prediction candidate; determine a decoded block of video data based on the prediction block for the chroma block; and output a decoded picture of video data that includes the decoded block of video data.

This application claims the benefit of U.S. Provisional Patent Application No. 63/587,969, filed 4 Oct. 2023, the entire contents of which is incorporated herein by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

The techniques of this disclosure relate to prediction and, more specifically, to cross-component prediction (CCP) modes and signaling for those modes. When coding a block in a CCP mode, a video decoder predicts samples for one component, such as a chroma component, based on samples of a different component, such as a luma component. As will be explained in more detail below, there are several CCP modes, which implement CCP in different manners. For a block coded in a CCP mode, signaling which specific CCP mode is used for the block can require a series of flags, which creates a significant signaling overhead for CCP mode coded blocks.

This disclosure describes techniques for signaling which CCP mode to use for a block of video data using merge candidate lists. A video decoder may, for example, derive a merge candidate list that includes a plurality of candidates. The video decoder may then receive a syntax element indicating which candidate in the list is to be used as the CCP mode. The quality of prediction achieved with CCP using merges signaling is a function of the quality of candidates in the merge list. To improve the quality candidates in the merge list, this disclosure describes techniques for including fusion candidates in the merge list. A fusion candidate generally refers to a candidate that is formed by combining two or more other CCP candidates using a combination model.

By configuring a video decoder to generate, for a chroma block, a merge candidate list that includes at least two prediction candidates generated by different CCP modes and a third prediction candidate generated by fusion. By including a fusion prediction candidate in the merge list candidate list, the techniques of this disclosure may improve the quality of prediction achieved by CCP without significantly increasing the signaling overhead associated with CCP mode.

According to an example of this disclosure, a method of decoding encoded video data includes: determining that a chroma block of the encoded video data is coded in a cross-component prediction (CCP) mode; generating a merge candidate list for the chroma block, wherein the merge candidate list includes at least two prediction candidates generated by different CCP modes and a third prediction candidate, wherein the third prediction candidate comprises a fusion prediction candidate; receiving, in the encoded video data, a syntax element set to a value; selecting a prediction candidate from the merge candidate list based on the value of the syntax element; determining a prediction block for the chroma block based on the selected prediction candidate; determining a decoded block of video data based on the prediction block for the chroma block; and outputting a decoded picture of video data that includes the decoded block of video data.

According to an example of this disclosure, a device for decoding encoded video data includes a memory configured to store video data and one or more processors implemented in circuitry and configured to: determine that a chroma block of the encoded video data is coded in a cross-component prediction (CCP) mode; generate a merge candidate list for the chroma block, wherein the merge candidate list includes at least two prediction candidates generated by different CCP modes and a third prediction candidate, wherein the third prediction candidate comprises a fusion prediction candidate; receive, in the encoded video data, a syntax element set to a value; select a prediction candidate from the merge candidate list based on the value of the syntax element; determine a prediction block for the chroma block based on the selected prediction candidate; determine a decoded block of video data based on the prediction block for the chroma block; and output a decoded picture of video data that includes the decoded block of video data.

According to an example of this disclosure, a method of encoding video data includes determining that a chroma block of the video data is encoded in a cross-component prediction (CCP) mode; generating a merge candidate list for the chroma block, wherein the merge candidate list includes at least two prediction candidates generated by different CCP modes and a third prediction candidate, wherein the third prediction candidate comprises a fusion prediction candidate; selecting a prediction candidate from the merge candidate list; and generating a bitstream of encoded video data, wherein the bitstream of encoded video data includes a syntax element set to a value, wherein the value corresponds to an index of the selected prediction candidate.

According to an example of this disclosure, a device for encoding video data includes a memory configured to store video data; one or more processors implemented in circuitry and configured to: determine that a chroma block of the video data is encoded in a cross-component prediction (CCP) mode; generate a merge candidate list for the chroma block, wherein the merge candidate list includes at least two prediction candidates generated by different CCP modes and a third prediction candidate, wherein the third prediction candidate comprises a fusion prediction candidate; select a prediction candidate from the merge candidate list; and generate a bitstream of encoded video data, wherein the bitstream of encoded video data includes a syntax element set to a value, wherein the value corresponds to an index of the selected prediction candidate.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 shows an example of the locations of the samples used for the derivation of parameters for cross-component linear model prediction.

FIG. 3 shows an illustration of slope adjustment.

FIG. 4 shows an example of a spatial part of a convolutional filter.

FIG. 5 shows an example of a reference area (with padding) used to derive the filter coefficients.

FIG. 6 is a block diagram illustrating an example video encoder that may perform the techniques of this disclosure.

FIG. 7 is a block diagram illustrating an example video decoder that may perform the techniques of this disclosure.

FIG. 8 is a flowchart illustrating an example process for encoding a current block in accordance with the techniques of this disclosure.

FIG. 9 is a flowchart illustrating an example process for decoding a current block in accordance with the techniques of this disclosure.

FIG. 10 is a flowchart illustrating an example process for encoding a current block in accordance with the techniques of this disclosure.

FIG. 11 is a flowchart illustrating an example process for decoding a current block in accordance with the techniques of this disclosure.

### DETAILED DESCRIPTION

Video coding (e.g., video encoding and/or video decoding) typically involves predicting a block of video data from either an already coded block of video data in the same picture (e.g., intra prediction) or an already coded block of video data in a different picture (e.g., inter prediction). In some instances, the video encoder also calculates residual data by comparing the prediction block to the original block. Thus, the residual data represents a difference between the prediction block and the original block. To reduce the number of bits needed to signal the residual data, the video encoder transforms and quantizes the residual data and signals the transformed and quantized residual data in the encoded bitstream. The compression achieved by the transform and quantization processes may be lossy, meaning that transform and quantization processes may introduce distortion into the decoded video data.

A video decoder decodes and adds the residual data to the prediction block to produce a reconstructed video block that matches the original video block more closely than the prediction block alone. Due to the loss introduced by the transforming and quantizing of the residual data, the first reconstructed block may have distortion or artifacts. One common type of artifact or distortion is referred to as blockiness, where the boundaries of the blocks used to code the video data are visible. To further improve the quality of decoded video, a video decoder may perform one or more filtering operations on the reconstructed video blocks, such as deblocking filtering, sample adaptive offset (SAO) filtering, and adaptive loop filtering (ALF).

The techniques of this disclosure relate to prediction and, more specifically, to cross-component prediction (CCP) modes and signaling for those modes. When coding a block in a CCP mode, a video decoder predicts samples for one component, such as a chroma component, based on samples of a different component, such as a luma component. As will be explained in more detail below, there are several CCP modes, which implement CCP in different manners. For a block coded in a CCP mode, signaling which specific CCP mode is used for the block can require a series of flags, which creates a significant signaling overhead for CCP mode coded blocks.

This disclosure describes techniques for signaling which CCP mode to use for a block of video data using merge candidate lists. A video decoder may, for example, derive a merge candidate list that includes a plurality of candidates. The video decoder may then receive a syntax element indicating which candidate in the list is to be used as the CCP mode. The quality of prediction achieved with CCP using merges signaling is a function of the quality of candidates in the merge list. To improve the quality candidates in the merge list, this disclosure describes techniques for including fusion candidates in the merge list. A fusion candidate generally refers to a candidate that is formed by combining two or more other CCP candidates using a combination model.

By configuring a video decoder to generate, for a chroma block, a merge candidate list that includes at least two prediction candidates generated by different CCP modes and a third prediction candidate generated by fusion. By including a fusion prediction candidate in the merge list candidate list, the techniques of this disclosure may improve the quality of prediction achieved by CCP without significantly increasing the signaling overhead associated with CCP mode.

As used in this disclosure, the term video coding generically refers to either video encoding or video decoding. Similarly, the term video coder may generically refer to a video encoder or a video decoder. Moreover, certain techniques described in this disclosure with respect to video decoding may also apply to video encoding, and vice versa. For example, often times video encoders and video decoders are configured to perform the same process, or reciprocal processes. Also, a video encoder typically performs video decoding (also called reconstruction) as part of the processes of determining how to encode video data. For example, a video encoder may perform deblocking filtering on decoded video blocks in order to determine whether a certain encoding scheme produces a desirable rate-distortion tradeoff and also so that the video encoder can perform motion estimation using the same blocks available to a video decoder when the video decoder performs motion compensation.

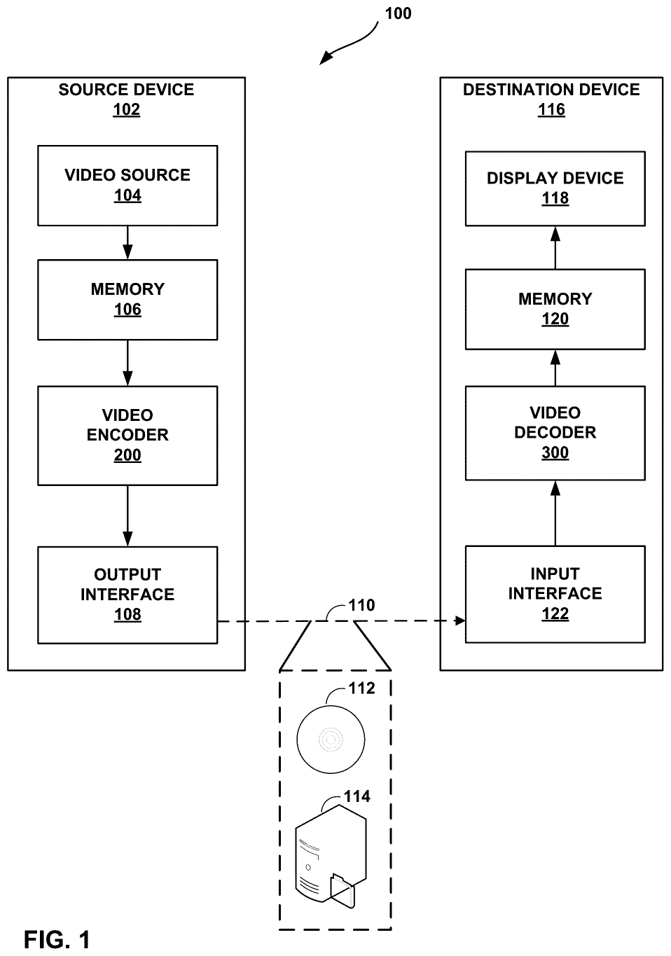

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for CCP. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform the techniques for CCP described herein. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use CCP.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

Video encoder 200 and video decoder 300 may be configured to perform cross-component linear model prediction (CCLM). To reduce the cross-component redundancy, CCLM prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 - 1 )$$

where pred_{C}(i,j) represents the predicted chroma samples in a CU and rec_{L}(i, j) represents the downsampled reconstructed luma samples of the same CU.

The CCLM parameters (α and β)) are derived with at most four neighboring chroma samples and their corresponding down-sampled luma samples. Suppose the current chroma block dimensions are W×H, then W″ and H′ are set as
W′=W, H′=H when LM mode is applied;
W′=W+H when LM-A mode is applied;
H′=H+W when LM-L mode is applied;

The above neighboring positions are denoted as S[0, −1] . . . S[W′−1, −1] and the left neighboring positions are denoted as S[−1, 0] . . . S[−1, H′−1]. Then the four samples are selected as
S[W′/4, −1], S[3*W′/4, −1], S[−1, H′/4], S[−1, 3*H′/4] when LM mode is applied and both above and left neighboring samples are available;
S[W′/8,−1],S[3*W′/8,−1],S[5*W′/8,−1],S[7*W′/8,−1] when LM-A mode is applied or only the above neighboring samples are available;
S[−1, H′/8], S[−1, 3*H′/8], S[−1, 5*H′/8], S[−1, 7*H′/8] when LM-L mode is applied or only the left neighboring samples are available;

The four neighboring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; {Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1 \qquad ( 1 - 2 )$$

Finally, the linear model parameters α and β are obtained according to the following equations.

$$α = \frac{{Y}_{a} - {Y}_{b}}{{X}_{a} - {X}_{b}} \qquad ( 1 - 3 )$$

$$β = {Y}_{b} - α \cdot {X}_{b} \qquad ( 1 - 4 )$$

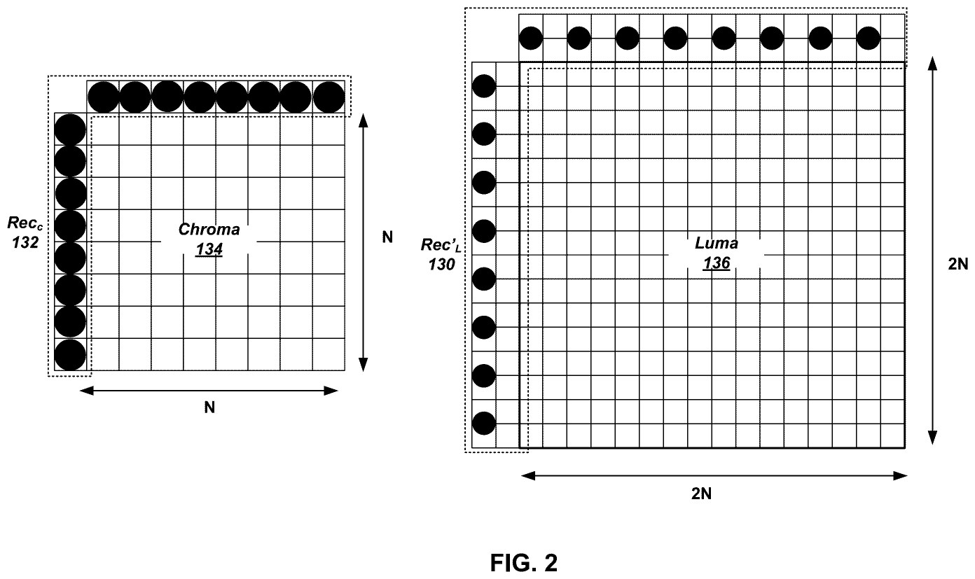

FIG. 2 shows the locations of the samples used for the derivation of α and β. FIG. 2 shows an example of the location of the left and above samples and the sample of the current block involved in the CCLM mode. In the example of FIG. 2, video encoder 200 and video decoder 300 may be configured to calculate α and β based on reconstrued luma samples 130 and reconstructed chroma samples 132. Video encoder 200 and video decoder 300 may then, using α and β, determine values for chroma samples 134 based on luma samples 136.

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0.7 , 6 , 5 , 5 , 4 , 4 , 3 , 3 , 2 , 2 , 1 , 1 , 1 , 1 , 0 \} \qquad ( 1 - 5 )$$

This would have a benefit of both reducing the complexity of the calculation as well as the memory size required for storing the needed tables

Besides the above template and left template can be used to calculate the linear model coefficients together, they also can be used alternatively in the other 2 LM modes, called LM_A, and LM_L modes.

In LM_T mode, only the above template are used to calculate the linear model coefficients. To get more samples, the above template are extended to (W+H) samples. In LM_L mode, only left template are used to calculate the linear model coefficients. To get more samples, the left template are extended to (H+W) samples.

In LM_LT mode, left and above templates are used to calculate the linear model coefficients.

To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsampling filters are as follows, which are corresponding to “type-0” and “type-2” content, respectively.

$${Rec}_{L}^{′} ( i , j ) = [ \begin{matrix}{rec}_{L} ( 2 i - 1 , 2 j - 1 ) + 2 \cdot {rec}_{L} ( 2 i - 1 , 2 j - 1 ) + \\ {rec}_{L} ( 2 i + 1 , 2 j - 1 ) + {rec}_{L} ( 2 i - 1 , 2 j ) + \\ 2 \cdot {rec}_{L} ( 2 i , 2 j ) + {rec}_{L} ( 2 i + 1 , 2 j ) + 4\end{matrix} ] ≫ 3 \qquad ( 1 - 6 )$$

$${rec}_{L}^{′} ( i , j ) = [ \begin{matrix}{rec}_{L} ( 2 i , 2 j - 1 ) + {rec}_{L} ( 2 i - 1 , 2 j ) + \\ 4 \cdot {rec}_{L} ( 2 i , 2 j ) + {rec}_{L} ( 2 i + 1 , 2 j ) + \\ {rec}_{L} ( 2 i , 2 j + 1 ) + 4\end{matrix} ] ≫ 3 \qquad ( 1 - 7 )$$

Note that only one luma line (general line buffer in intra prediction) is used to make the downsampled luma samples when the upper reference line is at the CTU boundary.

This parameter computation is performed as part of the decoding process, and is not just as an encoder search operation. As a result, no syntax is used to convey the α and β values to the decoder.

Video encoder 200 and video decoder 300 may be configured to implement multi-model LM (MMLM). CCLM included in VVC is extended by adding three MMLM modes (JVET-D0110). In each MMLM mode, the reconstructed neighboring samples are classified into two classes using a threshold which is the average of the luma reconstructed neighboring samples. The linear model of each class is derived using the Least-Mean-Square (LMS) process. For the CCLM mode, the LMS process is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples. In block matching search, the search range is set to cover both the previous and current CTUs.

Video encoder 200 and video decoder 300 may be configured to perform a slope adjustment of CCLM. CCLM uses a model with 2 parameters to map luma values to chroma values. The slope parameter “a” and the bias parameter “b” define the mapping as follows:

$$chromaVal = a * lumaVal + b$$

An adjustment “u” to the slope parameter is signaled to update the model to the following form:
where

$$chromaVal = {a}^{′} * lumaVal + {b}^{′} \\ {a}^{′} = a + u \\ {b}^{′} = b - u * yr .$$

With this selection the mapping function is tilted or rotated around the point with luminance value yᵣ. The average of the reference luma samples used in the model creation as yᵣ in order to provide a meaningful modification to the model. Picture below illustrates the process.

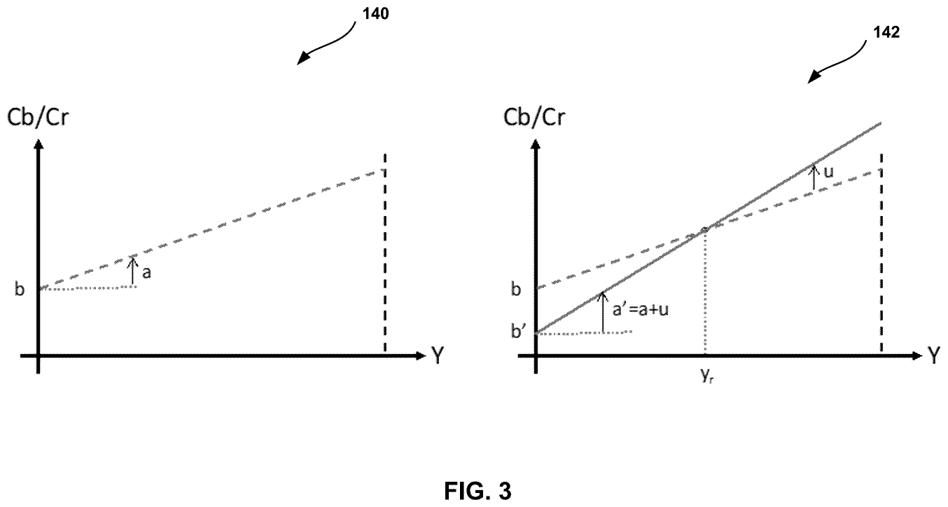

FIG. 3 shows an illustration of the effect of the slope adjustment parameter “u”. \grave{G}raph 140 shows a model created with the current CCLM. Graph 142 shows an updated model.

A slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

Video encoder 200 and video decoder 300 may be configured to implement a convolutional cross-component intra prediction model (CCCM). In such a process, CCCM is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

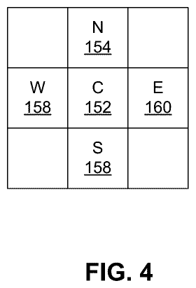

Video encoder 200 and video decoder 300 may be configured to utilize a convolutional filter. FIG. 4 shows an example of a spatial part of the convolutional filter. The convolutional 7-tap filter includes a 5-tap plus sign shape spatial component, a nonlinear term and a bias term. The input to the spatial 5-tap component of the filter includes a center luma sample (C 152) which is collocated with the chroma sample to be predicted and its above/north (N 154), below/south (S 156), left/west (W 158) and right/east (E 160) neighbors as illustrated below.

The nonlinear term P is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = c 0 C + c 1 N + c 2 S + c 3 E + c 4 W + c 5 P + c 6 B$$

Video encoder 200 and video decoder 300 may be configured to calculate filter coefficients. The filter coefficients ci are calculated by minimizing MSE between predicted and reconstructed chroma samples in the reference area.

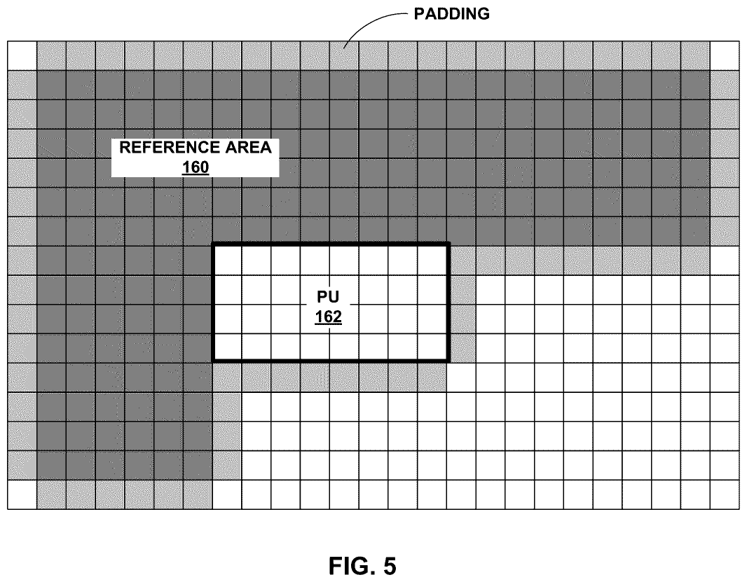

FIG. 5 shows an example of a reference area (with padding) used to derive the filter coefficients. FIG. 5 illustrates the reference area 160 which includes 2 or 6 lines of chroma samples above and left of the PU 162. Whether to use 6 lines or 2 lines of neighboring samples to derive the CCCM model parameters in the single model CCCM is determined by a template cost. Similarly, for the multi-model CCCM mode, the two candidates use 6 lines neighboring luma samples or luma samples collocated to the current chroma block to derive mean values which separate samples into two groups. The cost is derived by applying the candidate CCP (either 2 or 6 lines) on a template, calculating the sum of absolute difference (SAD) between CCP predicted samples and reconstructed samples in the template.

Reference area 160 extends one PU width to the right and one PU height below the boundaries of PU 162. Reference area 160 is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process roughly follows the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g., between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$${C}^{′} = C - offsetLuma \\ {N}^{′} = N - offsetLuma \\ {S}^{′} = S - offsetLuma \\ {E}^{′} = E - offsetLuma \\ {W}^{′} = W - offsetLuma \\ {P}^{′} = nonLinear ( {C}^{′} ) \\ B = midValue = 1 ≪ ( bitDepth - 1 )$$

and the chroma value is predicted using the following equation, where offsetChroma is equal to offsetCr and offsetCb for Cr and Cb components, respectively:

predChromaVal=c0C′+c1N′+c2S′+c3E′+c4W′+c5P′+c6B+offsetChroma

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation are replaced with multiplication (with a scale factor) and shift operation, where scale factor and number of shifts are calculated based on denominator similar to the process used in calculation of CCLM parameters.

Video encoder 200 and video decoder 300 may be configured to implement a gradient linear model (GLM). For YUV 4:2:0 color format, a gradient linear model (GLM) process can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization process as used in the CCCM.

$$C = {α}_{0} \cdot G + {α}_{1} \cdot L + {α}_{2} \cdot β$$

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.

Video encoder 200 and video decoder 300 may be configured to perform block-vector guided CCCM (BVG-CCCM). When the co-located luma prediction is coded with IBC or IntraTMP in Intra slices, the BVG-CCCM mode can be used. In this mode, the block vectors of the co-located luma blocks, coded in IBC or intraTMP modes, are used to determine the reference area for calculating the CCCM parameters. The prediction is performed using uses the calculated model parameters and co-located luma samples.

The BVG-CCCM mode uses an 11-tap filter for cross-component prediction as below:

$$predChromaVal = c 0 C + c 1 N + c 2 S + c 3 E + c 4 W + c 5 P ( C ) + c 6 P ( N ) + c 7 P ( S ) + c 8 P ( W ) + c 9 P ( E ) + c 10 B$$

The input to the spatial 5-tap component of the filter includes a center (C) luma sample which is collocated with the chroma sample to be predicted and its above/north (N), below/south (S), left/west (W) and right/east (E) neighbors as illustrated in FIG. 4.

The nonlinear term P is represented as power of two of the corresponding luma sample and B is the bias term.

Video encoder 200 and video decoder 300 may be configured to perform gradient and location based convolutional cross-component model (GL-CCCM). This process maps luma values into chroma values using a filter with inputs including one spatial luma sample, two gradient values, two location information, a nonlinear term, and a bias term. The GL-CCCM process uses gradient and location information instead of the 4 spatial neighbor samples used in the CCCM filter. The GL-CCCM filter used for the prediction is:

$$predChromaVal = {c}_{0} C + {c}_{1} {G}_{y} + {c}_{2} {G}_{x} + {c}_{3} Y + {c}_{4} X + {c}_{5} P + {c}_{6} B$$

Where G_{y} and Gₓ are the vertical and horizontal gradients, respectively, and are calculated as:

$${G}_{y} = ( 2 N + NW + NE ) - ( 2 S + SW + SE ) \\ {G}_{x} = ( 2 W + NW + SW ) - ( 2 E + NE + SE )$$

Moreover, the Y and X are the spatial coordinates of the center luma sample.

The rest of the parameters are the same as CCCM tool. The reference area for the parameter calculation is the same as for the CCCM process.

The usage of the mode is signaled with a CABAC coded PU level flag. When it comes to signaling, GL-CCCM is considered a sub-mode of CCCM. That is, the GL-CCCM flag is only signaled if original CCCM flag is true.

Similar to the CCCM, GL-CCCM tool has 6 modes for calculating the parameters:
Single-model GL-CCCM from above and left templates
Single-model GL-CCCM from above template
Single-model GL-CCCM from left template
Multi-model GL-CCCM from above and left templates
Multi-model GL-CCCM from above template
Multi-model GL-CCCM from left template

Video encoder 200 and video decoder 300 may be configured to perform CCCM with multiple downsampling filters. Multiple downsampling filters are applied to a group of reconstructed luma samples in a CCCM. The linear combination of these downsampled reconstructed samples is multiplied by derived filter coefficients to form the final chroma predictor. The horizontal or vertical location of the center luma sample are also considered in the tested model. The cross-component models shown below are tested as additional CCCM modes with a mode index signalled in the bitstream:

$$( 1 ) Model 1 : predChroma = c 0 * H ( C ) + c 1 * G 1 ( C ) + c 2 * G 2 ( C ) + c 3 * G 3 ( C ) + c 4 * P ( H ( C ) ) + c 5 * P ( G 1 ( C ) ) + c 6 * P ( G 2 ( C ) ) + c 7 * X + c 8 * Y + c 9 * B$$

$$( 2 ) Model 2 : predChroma = c 0 * H ( C ) + c 1 * H ( W ) + c 2 * H ( E ) + c 3 * G 1 ( C ) + c 4 * G 1 ( W ) + c 5 * G 1 ( E ) + c 6 * P ( H ( C ) ) + c 7 * P ( H ( W ) ) + c 8 * P ( H ( E ) ) + c 9 * X + c 10 * B$$

$$( 3 ) Model 3 : predChroma = c 0 * H ( C ) + c 1 * H ( NE ) + c 2 * H ( SW ) + c 3 * G 3 ( C ) + c 4 * G 3 ( NE ) + c 5 * G 3 ( SW ) + c 6 * P ( H ( C ) ) + c 7 * P ( H ( NE ) ) + c 8 * P ( H ( SW ) ) + c 9 * Y + c 10 * B$$

where H(⋅), G1(⋅), G2(⋅), G3(⋅) are various downsampling filters; C denotes the current chroma sample position; and N, S, W, E, NE, SW are the positions around C; ci are filter coefficients; P and B are nonlinear term and bias term; and X and Y are the horizontal and vertical locations of the center luma sample with respect to the top-left coordinates of the block

Video encoder 200 and video decoder 300 may be configured to perform local-boosting cross-component prediction (LB-CCP). Prediction samples of MM-CCLM/MM-CCCM can be filtered with neighboring samples. A 3×3 low-pass filter is applied to filter prediction samples generated by MM-CCLM/MM-CCCM. For a sample at a top/left boundary, the filtering window may involve neighboring reconstructed samples. For inner samples, the filtering window only involves prediction samples, which may be padded. A flag is signaled to indicate whether filtering is applied or not for a block coded with MM-CCLM/MM-CCCM.

Video encoder 200 and video decoder 300 may be configured to implement a cross-component prediction (CCP) merge (a.k.a., non-local CCP) mode. For chroma coding, a flag is signaled to indicate whether CCP mode (including the CCLM, CCCM, GLM and their variants) or non-CCP mode (conventional chroma intra prediction mode, fusion of chroma intra prediction mode) is used. If the CCP mode is selected, one more flag is signaled to indicate how to derive the CCP type and parameters, i.e., either from a CCP merge list or signaled/derived on-the-fly. a CCP merge candidate list is constructed from the spatial adjacent, temporal, spatial non-adjacent, history-based m or shifted temporal candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighboring template of the current block. More details are described below.

Video encoder 200 and video decoder 300 may be configured to include spatial adjacent and non-adjacent candidates. The positions and inclusion order of the spatial adjacent and non-adjacent candidates are the same as those defined in ECM for regular inter merge prediction candidates.

Video encoder 200 and video decoder 300 may be configured to include temporal and shifted temporal candidates. Temporal candidates are selected from the collocated picture. The position and inclusion order of the temporal candidates are the same as those defined in ECM for regular inter merge prediction candidates. The shifted temporal candidates are also selected from the collocated picture. The position of temporal candidates is shifted by a selected motion vector which is derived from motion vectors of neighboring blocks.

Video encoder 200 and video decoder 300 may be configured to include history-based candidates. A history-based table is maintained to include the recently used CCP models, and the table is reset at the beginning of each CTU row. If the current list is not full after including spatial adjacent and non-adjacent candidates, the CCP models in the history-based table are added into the list.

Video encoder 200 and video decoder 300 may be configured to include default candidates. CCLM candidates with default scaling parameters are considered only when the list is not full after including the spatial adjacent, spatial non-adjacent, or history-based candidates. If the current list has no candidates with the single model CCLM mode, the default scaling parameters are {0, 1/8, −1/8, 2/8, −2/8, 3/8, −3/8, 4/8, −4/8, 5/8, −5/8, 6/8}. Otherwise, the default scaling parameters are {0, the scaling parameter of the first CCLM candidate+{1/8, −1/8, 2/8, −2/8, 3/8, −3/8, 4/8, −4/8, 5/8, −5/8, 6/8}}.

A flag is signaled to indicate whether the CCP merge mode is applied or not. If CCP merge mode is applied, an index is signaled to indicate which candidate model is used by the current block. In addition, CCP merge mode is not allowed for the current chroma coding block when the current CU is coded by intra sub-partitions (ISP) with single tree, or the current chroma coding block size is less than or equal to 16.

To improve the coding efficiency of CCLM or CCP merge related tools, processes to select and fuse the different CCP merge candidates are described in this disclosure.

Video encoder 200 and video decoder 300 may be configured to perform fusion of the CCP merge candidates. In some examples, video encoder 200 and video decoder 300 may combine, for the current block, two or more CCP merge candidates by a combination equation, also referred to as a combination model, with the resulting prediction candidate being referred to as a fusion candidate. A CCP merge fusion candidate has a fusion number k≥2, which represents that the fusion candidate is a result of fusing k CCP merge candidates and k models, which represents the information of the k merge candidates. In some examples, a fusion type may also be included in a CCP merge fusion candidate, which represents the combination model to fuse the CCP merge fusion candidate.

In some examples, a combination model is the process to combine the k merge candidates. In one example, a linear combination may be used. The 0 to k candidates could be selected from 0 to N candidates from template matching. The combination can be formulated as follows:

$${P}_{( x , y )} = \frac{( {w}_{0} * {P}_{0 ( x , y )} + {w}_{1} * {P}_{1 ( x , y )} + … + {w}_{k} * {P}_{k ( x , y )} )}{( {w}_{0} + {w}_{1} + … + {w}_{k} )}$$

where P₀ . . . Pₖ are the selected k CCP merge candidates. In some examples, the combining weight wₖ may be equal among all candidates, which means w₀=w₁= . . . =wₖ. In some examples, the combining weight wₖ may be derived based on the template cost of each candidate. In some examples, the combining weights are signaled into the bitstream. In some examples, the combining weights are inherited from a coded block. In some examples, the combining weight wₖ may be the multiplicative inverse of the template cost of this candidate k.

In some examples, video decoder 300 may derive a CCP merge fusion candidate list to store the fusion candidates which are derived for the current CU. In some examples, the length for the CCP merge fusion list may be N.

In some examples, a CCP merge fusion mode flag is signaled, for example at a block level, to indicate whether the CCP merge fusion mode is used for the current block, and if CCP merge fusion mode is not used, then video decoder 300 may derive the predictor from a single CCP merge candidate. If CCP merge fusion mode is enabled, then a CCP merge fusion index is signaled to indicate which candidate in the candidate list is selected to predict the current block. In some examples, if CCP merge fusion mode is enabled, then a CCP merge fusion type flag is signaled to indicate which combination process or model derivation process is applied to predict the current block.

In some examples, if CCP merge fusion mode is enabled, then the CCP merge fusion type may be derived by video decoder 300 without signaling. Video decoder 300 may apply all available fusion types in the neighboring template region to generate the fused template. Then, video decoder 300 may calculate the template cost for each fusion type, and select the template type with the minimum template cost to perform the fusion.

In some examples, if CCP merge fusion mode uses linear combination, an additional fusion weight offset present flag is signaled to indicate that whether a weight offset needed to be applied after the weights of the linear combination are determined.

Video encoder 200 and video decoder 300 may be configured to perform a derivation process for the CCP merge fusion candidate list. In some examples, if the signaled CCP merge fusion candidate number is N, then video decoder 300 may derive M fusion candidates, where M>N at first. Then, video decoder 300 may calculate the fused template cost and select the first N fusion candidates to form the fusion candidate list. In some examples, the fusion candidate list derivation process has two stages. In the first stage, video decoder 300 derives the M available candidates, and in the second stage, video decoder 300 calculates a template cost reorders to select N candidates from the M candidates. In some examples, when the fused template cost is calculated, video decoder 300 may generate the k template predictors by the stored model information. Then, video decoder 300 may apply the combination equation to fuse the k template predictors to generate the fused template. In some examples, video decoder 300 may calculate the fused template cost by using the left and above regions of the current block as the template.

In some examples, if the length of CCP merge single candidate list is L, then the first stage fusion candidate list length is M=C₂^{L}, which means all two candidate combinations are selected. In some examples, if the length of CCP merge single candidate list is L, then the first stage fusion candidate list length M=C₂^{L}+C₃^{L}+ . . . +Cₚ^{L}, which means all two, three . . . p candidates combination are selected.

In some examples, when deriving the fusion candidate list in the first stage, if a fusion candidate satisfies some conditions, then video decoder 300 may remove the fusion candidate from the fusion candidate list. In some examples, if any one of the CCP merge candidate uses multi-model CCLM mode in this fusion candidate, then video decoder 300 may remove the fusion candidate from the fusion candidate list in the first stage. In some examples, if any one of the CCP merge candidate uses different CCLM mode from the others in this fusion candidate, then video decoder 300 may remove the fusion candidate from the fusion candidate list in the first stage.

In some examples, a fusion candidate includes k CCP merge candidates and has template costs C₀, C₁, . . . Cₖ₋₁. Tf the ratio of the largest template cost and the smallest template cost is larger than a threshold d, which is, max{C₀, . . . Cₖ₋₁}/min{C₀, . . . Cₖ₋₁}>d, then vd 3 may remove the fusion candidate from the fusion candidate list in the first stage.

Video encoder 200 and video decoder 300 may be configured to include additional candidates for a non-fusion CCP merge candidate list. In some examples, video decoder 300 may derive the pairwise candidates in the CCP merge candidate list, with the pairwise candidates being formed by two candidates. If the two candidates use single model, the pairwise candidates may be combines using the two models to a multi-model candidate with a threshold. When generating the predictor, if the current input down-sampled luma pixel is smaller than the threshold, then video decoder 300 may use model 1 to derive the chroma pixel, and otherwise, use model 2 to derive the chroma pixel.

In some examples, if one of the candidates uses multi-model and the other uses single model, the pairwise candidate may copy from the multi-model candidate but replace one of the models with the model of single model candidate. The threshold may be inherited from the multi-model candidate. In some examples, the threshold of the pairwise candidate is calculated by the mean value of the current block. In some examples, the threshold of the pairwise candidate is decided by the neighboring template region of the current block. In the decoder, the multi-model information of the pairwise candidate may be applied to the template region with several pre-defined or derived threshold, the threshold with the minimum template cost may be selected. In some examples, if 2 candidates use the different LM modes, the pairwise candidate is unavailable.

Video encoder 200 and video decoder 300 may be configured to perform CCP fusion with non-CCP modes. Video decoder 300 may be configured to fuse non-CCP modes (such as traditional intra modes and direct mode) with one of CCP modes. In some examples, video decoder 300 may form a CCP list by various CCP modes. In some examples, a constraint is applied to only allow a specific type of CCP modes (for example: multi-model CCPs) to be added to the list. An index is signaled to the bitstream to indicate which CCP is used. In one example, video decoder 300 constructs the list by CCLM and CCCM with multiple downsampled filters. The multi-model constraint is applied to disallow single-model to be added into the list.

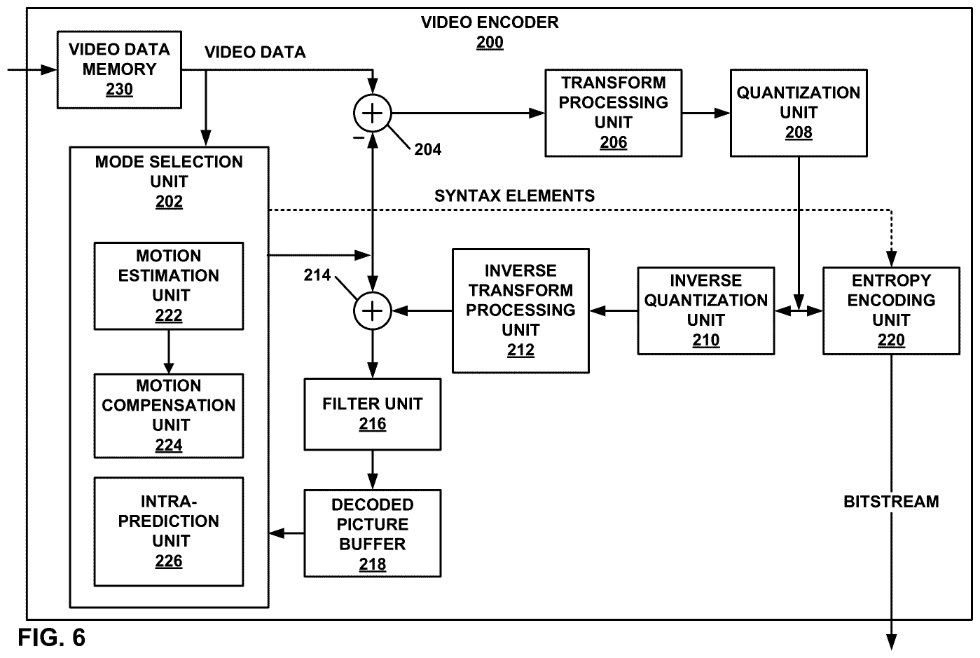

FIG. 6 is a block diagram illustrating an example video encoder 200 that may perform the techniques of this disclosure. FIG. 6 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 6, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 6 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to determine that a chroma block of video data is coded in a cross-component prediction mode; generate a merge candidate list for a block of video data, wherein the merge candidate list includes at least two candidates generated by different CCP modes; and determine a prediction block for the chroma block based on a candidate; and encode an index identifying the candidate in the merge candidate list.

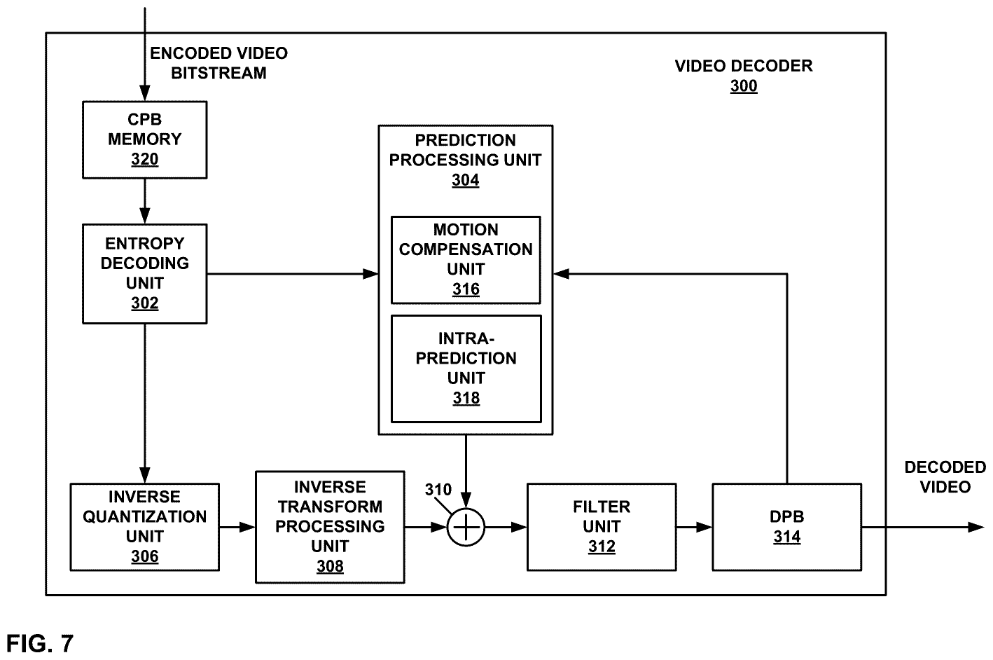

FIG. 7 is a block diagram illustrating an example video decoder 300 that may perform the techniques of this disclosure. FIG. 7 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 7, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 7 are illustrated to assist with understanding the operations performed by video decoder 300. The units may be implemented as fixed-function circuits, programmable circuits, or a combination thereof. Similar to FIG. 6, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 6).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 6). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to determine that a chroma block of video data is coded in a cross-component prediction mode; generate a merge candidate list for a block of video data, wherein the merge candidate list includes at least two candidates generated by different CCP modes; receive an index identifying a candidate in the merge candidate list; and determine a prediction block for the chroma block based on the identified candidate.

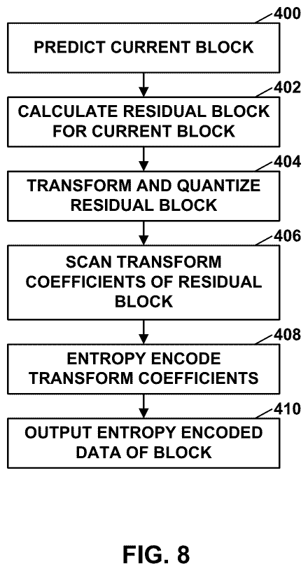

FIG. 8 is a flowchart illustrating an example process for encoding a current block in accordance with the techniques of this disclosure. The current block may be or include a current CU. Although described with respect to video encoder 200 (FIGS. 1 and 6), it should be understood that other devices may be configured to perform a process similar to that of FIG. 8.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

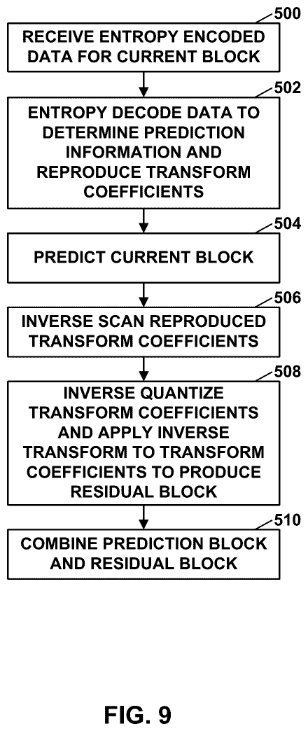

FIG. 9 is a flowchart illustrating an example process for decoding a current block of video data in accordance with the techniques of this disclosure. The current block may be or include a current CU. Although described with respect to video decoder 300 (FIGS. 1 and 7), it should be understood that other devices may be configured to perform a process similar to that of FIG. 9.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

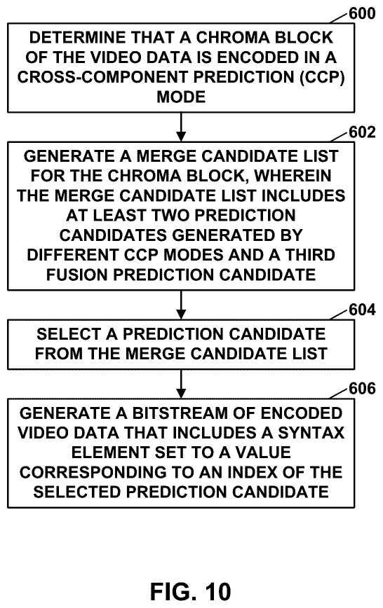

FIG. 10 is a flowchart illustrating an example process for encoding a current block in accordance with the techniques of this disclosure. The current block may be or include a current CU. Although described with respect to video encoder 200 (FIGS. 1 and 6), it should be understood that other devices may be configured to perform a process similar to that of FIG. 10.

In the example of FIG. 10, video encoder 200 determines that a chroma block of the video data is encoded in a cross-component prediction (CCP) mode (600). Video encoder 200 generates a merge candidate list for the chroma block, wherein the merge candidate list includes at least two prediction candidates generated by different CCP modes and a third fusion prediction candidate (602). Video encoder 200 may generate the merge candidate list using the same processes described with respect to video decoder 300. Video encoder 200 selects a prediction candidate from the merge candidate list (604). Video encoder 200 generates a bitstream of encoded video data that includes a syntax element set to a value corresponding to an index of the selected prediction candidate (606).

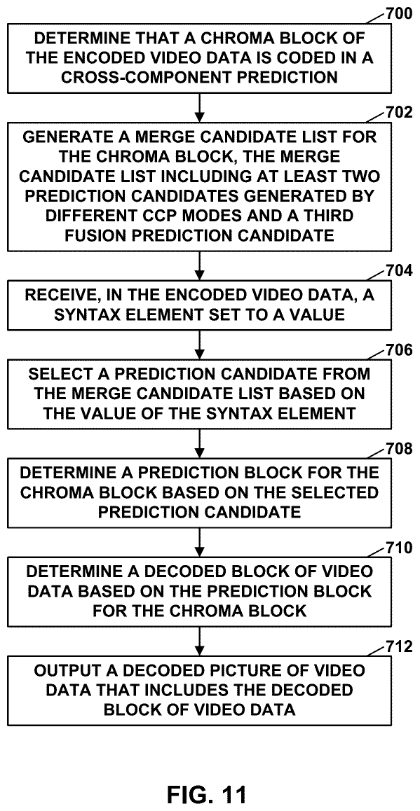

FIG. 11 is a flowchart illustrating an example process for decoding a current block of video data in accordance with the techniques of this disclosure. The current block may be or include a current CU. Although described with respect to video decoder 300 (FIGS. 1 and 7), it should be understood that other devices may be configured to perform a process similar to that of FIG. 11.

Video decoder 300 determines that a chroma block of the encoded video data is coded in a CCP mode (700). Video decoder 300 generate, for the chroma block, a merge candidate list that includes at least two prediction candidates generated by different CCP modes and a third fusion prediction candidate (702).

To determine the third fusion prediction candidate, video decoder 300 may be configured to generate a fusion candidate list for the chroma block. The fusion candidate list may include at least two fusion candidates, and video decoder 300 may select the third fusion prediction candidate for the merge candidate list from the fusion candidate list. In some examples, video decoder 300 may select the third fusion prediction candidate for the merge candidate list based on a comparison of template matching costs for the at least two fusion candidates.

To generate the merge candidate list, video decoder 300 may be configured to determine a first prediction candidate according to a CCP mode, determine a second prediction candidate according to the CCP mode, select one of the first prediction candidate or the second prediction candidate, and include the selected one of the first prediction candidate and the second prediction candidate in the merge candidate list.

To generate the merge candidate list, video decoder 300 may be configured to determine a first prediction candidate according to a first CCP mode, determine a second prediction candidate according to a second CCP mode, determine the fusion prediction candidate based on the first prediction candidate and the second prediction candidate, and include the fusion prediction candidate in the merge candidate list. To determine the first prediction candidate according to the first CCP mode, video decoder 300 may be configured to select the first prediction candidate from a first plurality of candidates based on template matching for each of the first plurality of candidates, and to determine the second prediction candidate according to the second CCP mode, video decoder 300 may be configured to select the second prediction candidate from a second plurality of candidates based on template matching for each of the second plurality of candidates. To determine the fusion prediction candidate based on the first prediction candidate and the second prediction candidate, video decoder 300 may be configured to determine a weighted combination of the first prediction candidate and the second prediction candidate. A weighting for the weighted combination may be an equal weighting. The first CCP mode may, for example, be a convolutional cross-component intra prediction model mode, and the second CCP mode may be a cross-component linear model mode.

Video decoder 300 receives, in the encoded video data, a syntax element set to a value (704). Video decoder 300 selects a prediction candidate from the merge candidate list based on the value of the syntax element (706). Each candidate in the marge candidate list may have a an index, and the value of the syntax element may correspond to the index of the prediction candidate that is to be selected.

Video decoder 300 determines a prediction block for the chroma block based on the selected prediction candidate (708). Video decoder 300 determines a decoded block of video data based on the prediction block for the chroma block (710). Video decoder 300 may, for example, add a residual block for the chroma block to the prediction block for the chroma block to determine a reconstructed block for the chroma block. Video decoder 300 may then apply one or more filters to the reconstructed block to determine a final decoded chroma block. Video decoder 300 may then combine the final decoded chroma block with a decoded luma block and an additional decoded chroma block to determine the decoded block of video.

Video decoder 300 outputs a decoded picture of video data that includes the decoded block of video data (712). Video decoder 300 may, for example, output the decoded picture of video data for storage, transmission, or display. Video decoder 300 may also output the decoded picture of video data for storage in a decoded picture buffer for use in decoding future blocks of video data.

The following numbered clauses illustrate one or more aspects of the devices and techniques described in this disclosure.

Clause 1A: A method of coding video data, the method comprising: determining that a chroma block of video data is coded in a cross-component prediction (CCP) mode; generating a merge candidate list for a block of video data, wherein the merge candidate list includes at least two candidates generated by different CCP modes; coding an index identifying a candidate in the merge candidate list; and determining a prediction block for the chroma block based on the identified candidate.

Clause 2A: The method of clause 1A, wherein generating the merge candidate list comprises: determining a first merge candidate according to a first CCP mode; determining a second merge candidate according to a second CCP mode; determining a fusion merge candidate based on the first merge candidate and the second merge candidate; and including the fusion merge candidate in the merge candidate list.

Clause 3A: The method of clause 1A, wherein generating the merge candidate list comprises: determining a first merge candidate according to a CCP mode; determining a second merge candidate according to the CCP mode; selecting one of the first merge candidate or the second merge candidate; and including the selected one of the first merge candidate and the second merge candidate in the merge candidate list.

Clause 4A: The method of any of clauses 1A-3A, wherein coding comprises decoding.

Clause 5A: The method of any of clauses 1A-3A, wherein coding comprises encoding.

Clause 6A: A device for coding video data, the device comprising one or more means for performing the method of any of clauses 1A-5A.

Clause 7A: The device of clause 6A, wherein the one or more means comprise one or more processors implemented in circuitry.

Clause 8A: The device of any of clauses 6A and 7A, further comprising a memory to store the video data. Clause 9A: The device of any of clauses 6A-8A, further comprising a display configured to display decoded video data.

Clause 10A: The device of any of clauses 6A-9A, wherein the device comprises one or more of a camera, a computer, a mobile device, a broadcast receiver device, or a set-top box.

Clause 11A: The device of any of clauses 6A-10A, wherein the device comprises a video decoder.

Clause 12A: The device of any of clauses 6A-11A, wherein the device comprises a video encoder.

Clause 13A: A computer-readable storage medium having stored thereon instructions that, when executed, cause one or more processors to perform the method of any of clauses 1A-5A.

Clause 14A: A device for coding video data, the device comprising: means for determining that a chroma block of video data is coded in a cross-component prediction mode; means for generating a merge candidate list for a block of video data, wherein the merge candidate list includes at least two candidates generated by different CCP modes; means for coding an index identifying a candidate in the merge candidate list; and means for determining a prediction block for the chroma block based on the identified candidate.

Clause 15A: The device of clause 14A, wherein the means for generating the merge candidate list comprises: means for determining a first merge candidate according to a first CCP mode; means for determining a second merge candidate according to a second CCP mode; means for determining a fusion merge candidate based on the first merge candidate and the second merge candidate; and means for including the fusion merge candidate in the merge candidate list.

Clause 16A: The device of clause 14A, wherein the means for generating the merge candidate list comprises: means for determining a first merge candidate according to a CCP mode; means for determining a second merge candidate according to the CCP mode; means for selecting one of the first merge candidate or the second merge candidate; and means for including the selected merge candidate in the merge candidate list.

Clause 1B: A method of decoding encoded video data, the method comprising: determining that a chroma block of the encoded video data is coded in a cross-component prediction (CCP) mode; generating a merge candidate list for the chroma block, wherein the merge candidate list includes at least two prediction candidates generated by different CCP modes and a third prediction candidate, wherein the third prediction candidate comprises a fusion prediction candidate; receiving, in the encoded video data, a syntax element set to a value; selecting a prediction candidate from the merge candidate list based on the value of the syntax element; determining a prediction block for the chroma block based on the selected prediction candidate; determining a decoded block of video data based on the prediction block for the chroma block; and outputting a decoded picture of video data that includes the decoded block of video data.

Clause 2B: The method of clause 1B, wherein generating the merge candidate list comprises: determining a first prediction candidate according to a CCP mode; determining a second prediction candidate according to the CCP mode; selecting one of the first prediction candidate or the second prediction candidate; and including the selected one of the first prediction candidate and the second prediction candidate in the merge candidate list.

Clause 3B: The method of clause 1B, wherein generating the merge candidate list comprises: determining a first prediction candidate according to a first CCP mode; determining a second prediction candidate according to a second CCP mode; determining the fusion prediction candidate based on the first prediction candidate and the second prediction candidate; and including the fusion prediction candidate in the merge candidate list.

Clause 4B: The method of clause 3B, wherein: determining the first prediction candidate according to the first CCP mode comprises selecting the first prediction candidate from a first plurality of candidates based on template matching for each of the first plurality of candidates; and determining the second prediction candidate according to the second CCP mode comprises selecting the second prediction candidate from a second plurality of candidates based on template matching for each of the second plurality of candidates.

Clause 5B: The method of clause 3B, wherein determining the fusion prediction candidate based on the first prediction candidate and the second prediction candidate comprises determining a weighted combination of the first prediction candidate and the second prediction candidate.

Clause 6B: The method of clause 5B, wherein a weighting for the weighted combination is an equal weighting.

Clause 7B: The method of clause 3B, wherein the first CCP mode comprises a convolutional cross-component intra prediction model mode and the second CCP mode comprises a cross-component linear model mode. Clause 8B: The method of any of clauses 1B-7B, further comprising: generating a fusion candidate list for the chroma block, wherein the fusion candidate list includes at least two fusion candidates; and selecting the third prediction candidate for the merge candidate list from the fusion candidate list.

Clause 9B: The method of clause 8B, further comprising: selecting the third prediction candidate for the merge candidate list based on a comparison of template matching costs for the at least two fusion candidates.

Clause 10B: A device for decoding encoded video data, the device comprising: a memory configured to store video data; one or more processors implemented in circuitry and configured to: determine that a chroma block of the encoded video data is coded in a cross-component prediction (CCP) mode; generate a merge candidate list for the chroma block, wherein the merge candidate list includes at least two prediction candidates generated by different CCP modes and a third prediction candidate, wherein the third prediction candidate comprises a fusion prediction candidate; receive, in the encoded video data, a syntax element set to a value; select a prediction candidate from the merge candidate list based on the value of the syntax element; determine a prediction block for the chroma block based on the selected prediction candidate; determine a decoded block of video data based on the prediction block for the chroma block; and output a decoded picture of video data that includes the decoded block of video data.

Clause 11B: The device of clause 10B, wherein to generate the merge candidate list, the one or more processors are further configured to: determine a first prediction candidate according to a CCP mode; determine a second prediction candidate according to the CCP mode; select one of the first prediction candidate or the second prediction candidate; and include the selected one of the first prediction candidate and the second prediction candidate in the merge candidate list.

Clause 12B: The device of clause 10B, wherein to generate the merge candidate list, the one or more processors are further configured to: determine a first prediction candidate according to a first CCP mode; determine a second prediction candidate according to a second CCP mode; determine the fusion prediction candidate based on the first prediction candidate and the second prediction candidate; and include the fusion prediction candidate in the merge candidate list.

Clause 13B: The device of clause 12B, wherein: to determine the first prediction candidate according to the first CCP mode, the one or more processors are further configured to select the first prediction candidate from a first plurality of candidates based on template matching for each of the first plurality of candidates; and to determine the second prediction candidate according to the second CCP mode, the one or more processors are further configured to select the second prediction candidate from a second plurality of candidates based on template matching for each of the second plurality of candidates.

Clause 14B: The device of clause 12B, wherein to determine the fusion prediction candidate based on the first prediction candidate and the second prediction candidate, the one or more processors are further configured to determine a weighted combination of the first prediction candidate and the second prediction candidate.

Clause 15B: The device of clause 14B, wherein a weighting for the weighted combination is an equal weighting.

Clause 16B: The device of clause 12B, wherein the first CCP mode comprises a convolutional cross-component intra prediction model mode and the second CCP mode comprises a cross-component linear model mode. Clause 17B: The device of any of clauses 10B-16B, wherein the one or more processors are further configured to: generate a fusion candidate list for the chroma block, wherein the fusion candidate list includes at least two fusion candidates; and select the third prediction candidate for the merge candidate list from the fusion candidate list.

Clause 18B: The device of clause 17B, wherein the one or more processors are further configured to: select the third prediction candidate for the merge candidate list based on a comparison of template matching costs for the at least two fusion candidates.

Clause 19B: A method of encoding video data, the method comprising: determining that a chroma block of the video data is encoded in a cross-component prediction (CCP) mode; generating a merge candidate list for the chroma block, wherein the merge candidate list includes at least two prediction candidates generated by different CCP modes and a third prediction candidate, wherein the third prediction candidate comprises a fusion prediction candidate; selecting a prediction candidate from the merge candidate list; and generating a bitstream of encoded video data, wherein the bitstream of encoded video data includes a syntax element set to a value, wherein the value corresponds to an index of the selected prediction candidate.

Clause 20B: The method of clause 19B, wherein generating the merge candidate list comprises: determining a first prediction candidate according to a CCP mode; determining a second prediction candidate according to the CCP mode; selecting one of the first prediction candidate or the second prediction candidate; and including the selected one of the first prediction candidate and the second prediction candidate in the merge candidate list.

Clause 21B: The method of clause 19B, wherein generating the merge candidate list comprises: determining a first prediction candidate according to a first CCP mode; determining a second prediction candidate according to a second CCP mode; determining the fusion prediction candidate based on the first prediction candidate and the second prediction candidate; and including the fusion prediction candidate in the merge candidate list.

Clause 22B: The method of clause 21B, wherein: determining the first prediction candidate according to the first CCP mode comprises selecting the first prediction candidate from a first plurality of candidates based on template matching for each of the first plurality of candidates; and determining the second prediction candidate according to the second CCP mode comprises selecting the second prediction candidate from a second plurality of candidates based on template matching for each of the second plurality of candidates.

Clause 23B: The method of clause 21B, wherein determining the fusion prediction candidate based on the first prediction candidate and the second prediction candidate comprises determining a weighted combination of the first prediction candidate and the second prediction candidate.

Clause 24B: The method of clause 23B, wherein a weighting for the weighted combination is an equal weighting.

Clause 25B: The method of clause 21B, wherein the first CCP mode comprises a convolutional cross-component intra prediction model mode and the second CCP mode comprises a cross-component linear model mode. Clause 26B: The method of any of clauses 19B-25B, further comprising: generating a fusion candidate list for the chroma block, wherein the fusion candidate list includes at least two fusion candidates; and selecting the third prediction candidate for the merge candidate list from the fusion candidate list.

Clause 27B: The method of clause 26B, further comprising: selecting the third prediction candidate for the merge candidate list based on a comparison of template matching costs for the at least two fusion candidates.

Clause 28B: A device for encoding video data, the device comprising: a memory configured to store video data; one or more processors implemented in circuitry and configured to: determine that a chroma block of the video data is encoded in a cross-component prediction (CCP) mode; generate a merge candidate list for the chroma block, wherein the merge candidate list includes at least two prediction candidates generated by different CCP modes and a third prediction candidate, wherein the third prediction candidate comprises a fusion prediction candidate; select a prediction candidate from the merge candidate list; and generate a bitstream of encoded video data, wherein the bitstream of encoded video data includes a syntax element set to a value, wherein the value corresponds to an index of the selected prediction candidate.

Clause 29B: The device of clause 28B, wherein to generate the merge candidate list, the one or more processors are further configured to: determine a first prediction candidate according to a CCP mode; determine a second prediction candidate according to the CCP mode; select one of the first prediction candidate or the second prediction candidate; and include the selected one of the first prediction candidate and the second prediction candidate in the merge candidate list.

Clause 30B: The device of clause 28B, wherein to generate the merge candidate list, the one or more processors are further configured to: determine a first prediction candidate according to a first CCP mode; determine a second prediction candidate according to a second CCP mode; determining the fusion prediction candidate based on the first prediction candidate and the second prediction candidate; and include the fusion prediction candidate in the merge candidate list.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding encoded video data, the method comprising:
determining that a chroma block of the encoded video data is coded in a cross-component prediction (CCP) mode;
generating a merge candidate list for the chroma block, wherein the merge candidate list includes at least two prediction candidates generated by different CCP modes and a third prediction candidate, wherein the third prediction candidate comprises a fusion prediction candidate;
receiving, in the encoded video data, a syntax element set to a value;
selecting a prediction candidate from the merge candidate list based on the value of the syntax element;
determining a prediction block for the chroma block based on the selected prediction candidate;
determining a decoded block of video data based on the prediction block for the chroma block; and
outputting a decoded picture of video data that includes the decoded block of video data.

2. The method of claim 1, wherein generating the merge candidate list comprises:
determining a first prediction candidate according to a CCP mode;
determining a second prediction candidate according to the CCP mode;
selecting one of the first prediction candidate or the second prediction candidate; and
including the selected one of the first prediction candidate and the second prediction candidate in the merge candidate list.

3. The method of claim 1, wherein generating the merge candidate list comprises:
determining a first prediction candidate according to a first CCP mode;
determining a second prediction candidate according to a second CCP mode;
determining the fusion prediction candidate based on the first prediction candidate and the second prediction candidate; and
including the fusion prediction candidate in the merge candidate list.

4. The method of claim 3, wherein:
determining the first prediction candidate according to the first CCP mode comprises selecting the first prediction candidate from a first plurality of candidates based on template matching for each of the first plurality of candidates; and
determining the second prediction candidate according to the second CCP mode comprises selecting the second prediction candidate from a second plurality of candidates based on template matching for each of the second plurality of candidates.

5. The method of claim 3, wherein determining the fusion prediction candidate based on the first prediction candidate and the second prediction candidate comprises determining a weighted combination of the first prediction candidate and the second prediction candidate.

6. The method of claim 5, wherein a weighting for the weighted combination is an equal weighting.

7. The method of claim 3, wherein the first CCP mode comprises a convolutional cross-component intra prediction model mode and the second CCP mode comprises a cross-component linear model mode.

8. The method of claim 1, further comprising:
generating a fusion candidate list for the chroma block, wherein the fusion candidate list includes at least two fusion candidates; and
selecting the third prediction candidate for the merge candidate list from the fusion candidate list.

9. The method of claim 8, further comprising:
selecting the third prediction candidate for the merge candidate list based on a comparison of template matching costs for the at least two fusion candidates.

10. A device for decoding encoded video data, the device comprising:
a memory configured to store video data;
one or more processors implemented in circuitry and configured to:
determine that a chroma block of the encoded video data is coded in a cross-component prediction (CCP) mode;
generate a merge candidate list for the chroma block, wherein the merge candidate list includes at least two prediction candidates generated by different CCP modes and a third prediction candidate, wherein the third prediction candidate comprises a fusion prediction candidate;
receive, in the encoded video data, a syntax element set to a value;
select a prediction candidate from the merge candidate list based on the value of the syntax element;
determine a prediction block for the chroma block based on the selected prediction candidate;
determine a decoded block of video data based on the prediction block for the chroma block; and
output a decoded picture of video data that includes the decoded block of video data.

11. The device of claim 10, wherein to generate the merge candidate list, the one or more processors are further configured to:
determine a first prediction candidate according to a CCP mode;
determine a second prediction candidate according to the CCP mode;
select one of the first prediction candidate or the second prediction candidate; and
include the selected one of the first prediction candidate and the second prediction candidate in the merge candidate list.

12. The device of claim 10, wherein to generate the merge candidate list, the one or more processors are further configured to:
determine a first prediction candidate according to a first CCP mode;
determine a second prediction candidate according to a second CCP mode;
determine the fusion prediction candidate based on the first prediction candidate and the second prediction candidate; and
include the fusion prediction candidate in the merge candidate list.

13. The device of claim 12, wherein:
to determine the first prediction candidate according to the first CCP mode, the one or more processors are further configured to select the first prediction candidate from a first plurality of candidates based on template matching for each of the first plurality of candidates; and
to determine the second prediction candidate according to the second CCP mode, the one or more processors are further configured to select the second prediction candidate from a second plurality of candidates based on template matching for each of the second plurality of candidates.

14. The device of claim 12, wherein to determine the fusion prediction candidate based on the first prediction candidate and the second prediction candidate, the one or more processors are further configured to determine a weighted combination of the first prediction candidate and the second prediction candidate.

15. The device of claim 14, wherein a weighting for the weighted combination is an equal weighting.

16. The device of claim 12, wherein the first CCP mode comprises a convolutional cross-component intra prediction model mode and the second CCP mode comprises a cross-component linear model mode.

17. The device of claim 10, wherein the one or more processors are further configured to:
generate a fusion candidate list for the chroma block, wherein the fusion candidate list includes at least two fusion candidates; and
select the third prediction candidate for the merge candidate list from the fusion candidate list.

18. The device of claim 17, wherein the one or more processors are further configured to:
select the third prediction candidate for the merge candidate list based on a comparison of template matching costs for the at least two fusion candidates.

19. A method of encoding video data, the method comprising:
determining that a chroma block of the video data is encoded in a cross-component prediction (CCP) mode;
generating a merge candidate list for the chroma block, wherein the merge candidate list includes at least two prediction candidates generated by different CCP modes and a third prediction candidate, wherein the third prediction candidate comprises a fusion prediction candidate;
selecting a prediction candidate from the merge candidate list; and
generating a bitstream of encoded video data, wherein the bitstream of encoded video data includes a syntax element set to a value, wherein the value corresponds to an index of the selected prediction candidate.

20. The method of claim 19, wherein generating the merge candidate list comprises:
determining a first prediction candidate according to a CCP mode;
determining a second prediction candidate according to the CCP mode;
selecting one of the first prediction candidate or the second prediction candidate; and
including the selected one of the first prediction candidate and the second prediction candidate in the merge candidate list.

21. The method of claim 19, wherein generating the merge candidate list comprises:
determining a first prediction candidate according to a first CCP mode;
determining a second prediction candidate according to a second CCP mode;
determining the fusion prediction candidate based on the first prediction candidate and the second prediction candidate; and
including the fusion prediction candidate in the merge candidate list.

22. The method of claim 21, wherein:
determining the first prediction candidate according to the first CCP mode comprises selecting the first prediction candidate from a first plurality of candidates based on template matching for each of the first plurality of candidates; and
determining the second prediction candidate according to the second CCP mode comprises selecting the second prediction candidate from a second plurality of candidates based on template matching for each of the second plurality of candidates.

23. The method of claim 21, wherein determining the fusion prediction candidate based on the first prediction candidate and the second prediction candidate comprises determining a weighted combination of the first prediction candidate and the second prediction candidate.

24. The method of claim 23, wherein a weighting for the weighted combination is an equal weighting.

25. The method of claim 21, wherein the first CCP mode comprises a convolutional cross-component intra prediction model mode and the second CCP mode comprises a cross-component linear model mode.

26. The method of claim 19, further comprising:
generating a fusion candidate list for the chroma block, wherein the fusion candidate list includes at least two fusion candidates; and
selecting the third prediction candidate for the merge candidate list from the fusion candidate list.

27. The method of claim 26, further comprising:
selecting the third prediction candidate for the merge candidate list based on a comparison of template matching costs for the at least two fusion candidates.

28. A device for encoding video data, the device comprising:
a memory configured to store video data;
one or more processors implemented in circuitry and configured to:
determine that a chroma block of the video data is encoded in a cross-component prediction (CCP) mode;
generate a merge candidate list for the chroma block, wherein the merge candidate list includes at least two prediction candidates generated by different CCP modes and a third prediction candidate, wherein the third prediction candidate comprises a fusion prediction candidate;
select a prediction candidate from the merge candidate list; and
generate a bitstream of encoded video data, wherein the bitstream of encoded video data includes a syntax element set to a value, wherein the value corresponds to an index of the selected prediction candidate.

29. The device of claim 28, wherein to generate the merge candidate list, the one or more processors are further configured to:
determine a first prediction candidate according to a CCP mode;
determine a second prediction candidate according to the CCP mode;
select one of the first prediction candidate or the second prediction candidate; and
include the selected one of the first prediction candidate and the second prediction candidate in the merge candidate list.

30. The device of claim 28, wherein to generate the merge candidate list, the one or more processors are further configured to:
determine a first prediction candidate according to a first CCP mode;
determine a second prediction candidate according to a second CCP mode;
determining the fusion prediction candidate based on the first prediction candidate and the second prediction candidate; and
include the fusion prediction candidate in the merge candidate list.
